(19) United States
(12) Patent Application Publication
(10) Pub. No.: US 2024/0004379 A1
(43) Pub. Date: Jan. 4, 2024

(54) ANOMALY CLASSIFICATION DEVICE

(71) Applicant: FANUC CORPORATION, Yamanashi (JP)

(72) Inventors: Kazuhiro SATOU, Yamanashi (JP); Kazunori IIJIMA, Yamanashi (JP); Motoki SATO, Tokyo (JP)

(21) Appl. No.: 18/254,602

(22) PCT Filed: Dec. 22, 2021
(86) PCT No.: PCT/JP2021/047724

§ 371 Date: May 26, 2023

(30) Foreign Application Priority Data
Dec. 25, 2020 (JP) 2020-216098

(51) Int. Cl. G05B 23/02

(52) U.S. Cl. CPC G05B 23/0275; G05B 23/0221

(57) ABSTRACT

An anomaly classification device determines whether a detected anomaly is a known anomaly or an unknown anomaly and presents to the user how to manage the detected anomaly not only for a case of a known anomaly but also for a case of an unknown anomaly. This anomaly classification device acquires, as anomaly data, data related to a physical quantity detected when an anomaly occurred in an industrial machine, creates a model used for determining whether or not the anomaly data is anomaly data that is based on a known anomaly cause and a model used for classifying which anomaly cause the anomaly data belongs to, and uses the created models to determine whether or not the anomaly data is based on a known anomaly cause and classify which anomaly cause the anomaly data is based on.

### RELATED APPLICATIONS

The present application is a National Phase of International Application No. PCT/JP2021/047724 filed Dec. 22, 2021, which claims priority to Japanese Application No. 2020-216098 filed Dec. 25, 2020.

### TECHNICAL FIELD

The present invention relates to an anomaly classification device that classifies anomalies occurring in an industrial machine.

### BACKGROUND ART

In manufacturing sites such as a factory, industrial machines such as machine tools or robots are installed to configure a manufacturing line, and respective industrial machines are controlled to manufacture products. Respective industrial machines are provided with sensors that measure physical quantities related to the operational state (a value of current, a value of a voltage, a temperature, vibration, a sound, or the like related to each unit), and based on the physical quantities detected by these sensors, it is possible to detect whether these industrial machines operate within a normal range or operate abnormally.

To detect an abnormal operation of an industrial machine, a model to detect a normal state or an abnormal state is created based on data related to physical quantities detected during the industrial machine being operating, and the operation of the industrial machine is determined based on the model. In such a situation, an industrial machine usually operates normally and less frequently operates abnormally. It is thus difficult to collect data related to physical quantities detected when an industrial machine is operating abnormally. Thus, to detect an abnormal operation of an industrial machine, unsupervised learning is performed using data detected when the industrial machine is operating within a normal range, and a model created as a result of the unsupervised learning is used to detect a state that is far from the normal operation of the industrial machine as an abnormal operation (Patent Literature 1 and the like).

### CITATION LIST

### Patent Literature

Patent Literature 1: Japanese Patent Application Laid-Open No. 2017-033470

### SUMMARY OF INVENTION

### Technical Problem

When an anomaly is detected, a user may identify a cause of the anomaly based on data acquired when the anomaly is detected and determine what to do for resolving the anomaly. This is because the severity of the anomaly or an action to be taken by the user will differ in accordance with the location of a failure or the type of the failure causing the anomaly.

On the other hand, much time and cost are required for collecting data related to physical quantities detected when industrial machines operate abnormally. It is thus difficult to initially prepare models that classifies all types of anomalies that may occur in the industrial machine into the anomaly causes thereof.

It is thus desirable to determine whether or not a detected anomaly is a known anomaly and present to the user how to manage the detected anomaly not only for a case of a known anomaly but also for a case of an unknown anomaly.

### Solution to Problem

An anomaly classification device according to one aspect of the present invention achieves the above object by classifying data obtained in the event of an anomaly based on abnormal instances that occurred in the past and presenting a classification result to the user.

Further, one aspect of the present invention is an anomaly classification device that classifies an anomaly occurring in an industrial machine, and the anomaly classification device includes: an anomaly data acquisition unit configured to acquire, as anomaly data, data related to a physical quantity detected when an anomaly occurred in an industrial machine; an anomaly data storage unit configured to store the anomaly data; a learning unit configured to use anomaly data stored in the anomaly data storage unit to create a model used for determining whether or not the anomaly data is anomaly data that is based on a known anomaly cause and a model used for classifying which anomaly cause the anomaly data belongs to; a known anomaly determination unit configured to use the model created by the learning unit to determine whether or not the anomaly data is based on a known anomaly cause; and an anomaly data classification unit configured to use the model created by the learning unit to classify which anomaly cause the anomaly data is based on.

### Advantageous Effects of Invention

One aspect of the present invention enables classification of anomaly patterns based on data obtained in the event of an anomaly without requiring prior knowledge for anomaly pattern classification and also enables accurate determination for an unknown anomaly by performing determination as to whether or not anomaly data is based on a known anomaly cause separately from the classification of anomaly patterns.

### BRIEF DESCRIPTION OF DRAWINGS

FIG. 1 is a schematic hardware configuration diagram of an anomaly classification device according to one embodiment.

FIG. 2 is a schematic function block diagram of an anomaly classification device according to a first embodiment.

FIG. 3 is a display example of a classification result of anomaly causes.

FIG. 4 is a display example of unknown anomaly causes.

FIG. 5 is another display example of a classification result of anomaly causes.

FIG. 6 is a schematic function block diagram of an anomaly classification device according to a second embodiment.

### DESCRIPTION OF EMBODIMENTS

Embodiments of the present invention will be described below with reference to the drawings.

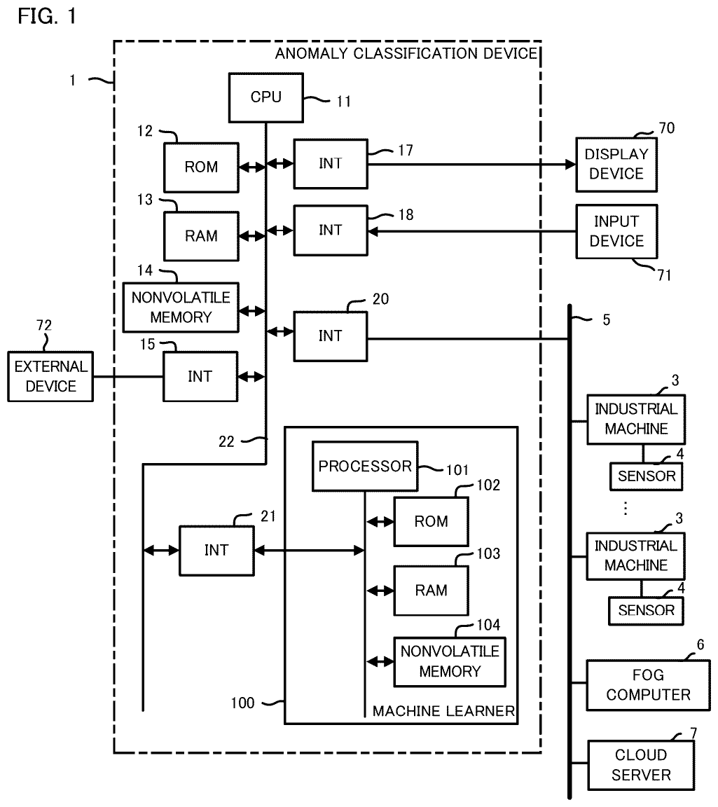

FIG. 1 is a schematic hardware configuration diagram illustrating a main part of an anomaly classification device according to one embodiment of the present invention.

An anomaly classification device 1 according to the present invention can be implemented as a control device that controls industrial machines including a machine tool, a robot, or the like based on a control program, for example, and can also be implemented on a computer such as a personal computer installed along with a control device that controls industrial machines including a machine tool, a robot, or the like based on a control program, a personal computer, a cell computer, a fog computer 6, a cloud server 7, or the like connected to the control device via a wired/wireless network. In the present embodiment, an example in which the anomaly classification device 1 is implemented on a personal computer connected to the control device via a network is illustrated.

A CPU 11 of the anomaly classification device 1 according to the present embodiment is a processor that controls the anomaly classification device 1 as a whole. The CPU 11 reads a system program stored in a ROM 12 via a bus 22 and controls the overall anomaly classification device 1 in accordance with the system program. A RAM 13 temporarily stores temporary calculation data or display data and various externally input data or the like.

A nonvolatile memory 14 is formed of a memory backed up by a battery (not illustrated), a solid state drive (SSD), or the like, for example, and the storage state thereof is held even when the anomaly classification device 1 is powered off. A nonvolatile memory 14 stores data loaded from an external device 72 via an interface 15, data input via an input device 71, data detected by sensors 4 acquired from industrial machines 3 via a network 5, or the like. The data stored in the nonvolatile memory 14 may be loaded into the RAM 13 during execution/during use. Further, various system programs such as a known analysis program are written in advance in the ROM 12.

Each sensor 4 that detects physical quantities such as current, a voltage, a temperature, vibration, a sound, or the like of respective units during an operation of the industrial machine 3 is mounted to the industrial machine 3. The industrial machine 3 may be, for example, a machine tool, a robot, or the like.

The interface 15 is an interface for connecting the CPU 11 of the anomaly classification device 1 and the external device 72 such as a USB device to each other. For example, data related to the operation of each industrial machine or the like can be loaded from the external device 72. Further, a program, setting data, or the like edited inside the anomaly classification device 1 can be stored in an external storage unit via the external device 72.

An interface 20 is an interface for connecting the CPU of the anomaly classification device 1 and the wired or wireless network 5 to each other. The industrial machine 3, the fog computer 6, the cloud server 7, and the like are connected to the network 5 and transfer data to and from the anomaly classification device 1.

On a display device 70, various data loaded on a memory, data obtained as a result of execution of a program or the like, data output from a machine learner 100 described later, or the like are output and displayed via an interface 17. Further, the input device 71 formed of a keyboard, a pointing device, or the like passes an instruction based on an operator's operation, data, or the like to the CPU 11 via an interface 18.

An interface 21 is an interface for connecting the CPU 11 and the machine learner 100 to each other. The machine learner 100 includes a processor 101 that controls the overall machine learner 100, a ROM 102 storing a system program or the like, an RAM 103 for performing temporary storage in each process related to machine learning, and a nonvolatile memory 104 used for storing a model or the like. The machine learner 100 can observe each information that can be acquired by the anomaly classification device 1 (for example, data indicating the operation state of the industrial machine 3) via the interface 21. Further, the anomaly classification device 1 acquires a process result output from the machine learner 100 via the interface 21, stores and displays the acquired result, and transmits the acquired result to another device via the network 5 or the like.

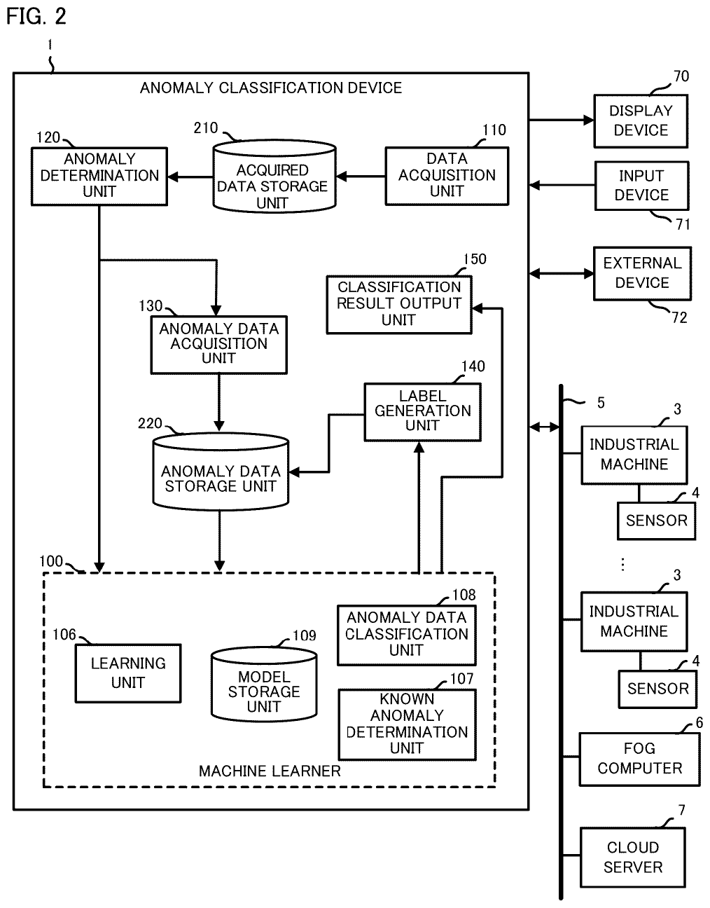

FIG. 2 illustrates functions of the anomaly classification device 1 according to the first embodiment of the present invention as a schematic block diagram.

Each function of the anomaly classification device 1 according to the present embodiment is implemented when the CPU 11 of the anomaly classification device 1 and the processor 101 of the machine learner 100 illustrated in FIG. 1 execute the system program and control the operation of each unit of the anomaly classification device 1 and the machine learner 100.

The anomaly classification device 1 of the present embodiment includes a data acquisition unit 110, an anomaly determination unit 120, an anomaly data acquisition unit 130, a label generation unit 140, and a classification result output unit 150. Further, the machine learner 100 of the anomaly classification device 1 includes a learning unit 106, a known anomaly determination unit 107, and an anomaly data classification unit 108. Furthermore, in the RAM 13 or the nonvolatile memory 14 of the anomaly classification device 1, an acquired data storage unit 210 is prepared as an area for storing data acquired from the industrial machine 3 or the like by the data acquisition unit 110, and an anomaly data storage unit 220 is prepared for storing, as anomaly data, data determined by the anomaly determination unit 120 as data indicating an abnormal state. In the RAM 103 or the nonvolatile memory 104 of the machine learner 100, a model storage unit 109 is prepared as an area in which models created by machine learning performed by the learning unit 106 is stored.

The data acquisition unit 110 is implemented when the CPU 11 of the anomaly classification device 1 illustrated in FIG. 1 executes the system program read from the ROM 12 to cause a calculation process using the RAM 13 or the nonvolatile memory 14 mainly performed by the CPU 11 and an input control process performed by the interface 15, 18, or to take place. The data acquisition unit 110 acquires data related to physical quantities detected by the sensors 4 during operations of the industrial machines 3. The data acquisition unit 110 acquires data related to a physical quantity such as a value of current or voltage flowing in and applied to each part during the operation of the industrial machines 3, a temperature (heat quantity), vibration, a sound, or the like detected by the sensors 4 mounted to the industrial machines 3, for example. The data acquired by the data acquisition unit 110 may be an instantaneous value acquired at a predetermined timing or may be time-series data acquired over a predetermined period. Further, the data acquisition unit 110 may acquire data directly from the industrial machine 3 via the network 5 or may acquire data that has been acquired and stored by the external device 72, the fog computer 6, the cloud server 7, or the like. The data acquired by the data acquisition unit 110 is stored in the acquired data storage unit 210.

The anomaly determination unit 120 is implemented when the CPU 11 of the anomaly classification device 1 illustrated in FIG. 1 executes the system program read from the ROM 12 to cause a calculation process using the RAM 13 or the nonvolatile memory 14 mainly performed by the CPU 11 to take place. The anomaly determination unit 120 determines the operation state of the industrial machine 3 based on data related to a physical quantity detected during the operation of the industrial machine 3 acquired by the data acquisition unit 110. The determination for the operation state of the industrial machine 3 performed by the anomaly determination unit 120 may be such that, for example, it is determined that an anomaly is occurring when a value calculated based on data related to a predetermined physical quantity exceeds a predefined predetermined threshold, it is determined that the operation of the industrial machine 3 is a normal state/an abnormal state based on a predetermined model for a result where a statistical process has been performed on data related to a physical quantity, or otherwise, it is determined that the operation of the industrial machine 3 is a normal state/an abnormal state by using a scheme of machine learning such as known unsupervised learning, supervised learning, or the like. When a scheme of machine learning is used, for example, it is preferable to use a scheme of One-Class Classifier such as One Class SVM, MT method, local outlier factor, Auto Encoder, Variational Auto Encoder, or the like. When a scheme of machine learning is used, the anomaly determination unit 120 may be constructed on the machine learner 100. The anomaly determination unit 120 outputs, to the machine learner 100, data related to physical quantities determined as those having been acquired when the operation of the industrial machine 3 was abnormal.

The anomaly data acquisition unit 130 is implemented when the CPU 11 of the anomaly classification device 1 illustrated in FIG. 1 executes the system program read from the ROM 12 to cause a calculation process using the RAM 13 or the nonvolatile memory 14 mainly performed by the CPU 11 to take place. The anomaly data acquisition unit 130 acquires, as anomaly data, data related to physical quantities determined by the anomaly determination unit 120 as those having been acquired when the operation of the industrial machine 3 was abnormal and stores the acquired anomaly data in the anomaly data storage unit 220.

The learning unit 106 of the machine learner 100 is implemented when the processor 101 of the machine learner 100 illustrated in FIG. 1 executes the system program read from the ROM 102 to cause a calculation process using the RAM 103 or the nonvolatile memory 104 mainly performed by the processor 101 to take place. The learning unit 106 creates a model used in a determination process related to anomaly data based on anomaly data stored in the anomaly data storage unit 220 and stores the created model in the model storage unit 109. The learning unit 106 uses anomaly data labeled with an anomaly cause out of anomaly data stored in the anomaly data storage unit 220 when creating a model. The model created by the learning unit 106 includes a model that takes at least anomaly data as input and can be used for determining whether or not the anomaly is due to a known anomaly cause and a model that, when the anomaly is due to a known anomaly cause, can be used for classifying which anomaly cause the anomaly data is based on. The model for determining whether or not the anomaly is due to a known anomaly cause and the model for classifying the anomaly cause may be created separately as follows. For example, One Class SVM, MT method, local outlier factor, Auto Encoder, Variational Auto Encoder, or the like may be used as the model for determining whether or not the anomaly is due to a known anomaly cause. Further, k-nearest neighbor, linear determination analysis, a neural network, or the like may be used as the model for classifying the anomaly cause. Parameters (hyperparameters, thresholds, or the like) for respective models may be set by the user.

Note that the model used for determining whether or not the anomaly data is anomaly data that is based on a known anomaly cause and the model used for classifying which anomaly cause the anomaly data is based on may be created as a single common classification model. In such a case, a classification model that takes anomaly data as input and outputs, as a score, a certainty factor indicating which class the anomaly data belongs to can be used as a classification model. For example, a value of a Softmax function in the output layer of a neural network can be output as the certainty factor for a class classification result. When such a model is used, it can be determined that the anomaly data is not based on any known anomaly cause if the certainty factor output from the model is below a predefined predetermined threshold for all the classes (labels of anomaly causes). In contrast, if there is a class for which the certainty factor output from the model is above a certain value, it can be determined that the anomaly data is anomaly data classified into the class.

The learning unit 106 stores created models in the model storage unit 109.

The known anomaly determination unit 107 of the machine learner 100 is implemented when the processor 101 of the machine learner 100 illustrated in FIG. 1 executes the system program read from the ROM 102 to cause a calculation process using the RAM 103 or the nonvolatile memory 104 mainly performed by the processor 101 to take place. Based on data related to physical quantities determined by the anomaly determination unit 120 as those having been acquired when the operation of the industrial machine 3 was abnormal, the known anomaly determination unit 107 determines whether or not the anomaly that occurred in the industrial machine 3 is based on a known anomaly cause. The known anomaly determination unit 107 uses a model stored in the model storage unit 109 to determine whether or not data determined as abnormal by the anomaly determination unit 120 is based on a known anomaly cause. If the known anomaly determination unit 107 determines that the anomaly that occurred in the industrial machine 3 is based on a known anomaly cause, the known anomaly determination unit 107 instructs the anomaly data classification unit 108 to classify the anomaly cause. Further, if the known anomaly determination unit 107 determines that the anomaly is not based on a known anomaly cause, that is, determines that an unknown anomaly cause occurred, the known anomaly determination unit 107 instructs the label generation unit 140 to provide a label.

The anomaly data classification unit 108 of the machine learner 100 is implemented when the processor 101 of the machine learner 100 illustrated in FIG. 1 executes the system program read from the ROM 102 to cause a calculation process using the RAM 103 or the nonvolatile memory 104 mainly performed by the processor 101 to take place. For anomaly data for which the known anomaly determination unit 107 has determined that an anomaly that occurred in the industrial machine 3 is based on a known anomaly cause, the anomaly data classification unit 108 classifies and outputs the cause of the anomaly. For example, when the model stored in the model storage unit 109 is k-nearest neighbor or the like, the anomaly data classification unit 108 classifies the anomaly cause based on which cluster the anomaly data is close to. Further, for example, when the model stored in the model storage unit 109 is a neural network or the like that output a score of an anomaly cause, classification of the anomaly cause is performed based on a score calculated based on the anomaly data. The anomaly data classification unit 108 outputs a result of the classification of the anomaly cause to the classification result output unit 150.

The label generation unit 140 is implemented when the CPU 11 of the anomaly classification device 1 illustrated in FIG. 1 executes the system program read from the ROM 12 to cause a calculation process using the RAM 13 or the nonvolatile memory 14 mainly performed by the CPU 11 and an input/output process using the interface 17, 18, or the like to take place. For anomaly data determined by the known anomaly determination unit 107 to be not based on a known anomaly cause, the label generation unit 140 generates a label related to the anomaly cause (a label representing a meaning about operation or maintenance of a machine). For example, the label generation unit 140 may display, on the display device 70, anomaly data for which the anomaly that occurred in the industrial machine 3 is determined to be not based on a known anomaly cause and, based on information about an anomaly cause input via the input device 71 by the user to the displayed anomaly data, generate a label related to the anomaly cause; may acquire, from the industrial machine 3, alarm information that occurred after anomaly data was acquired and then generate a label related to an anomaly cause based on the acquired alarm information; or otherwise may identify an anomaly cause comprehensively based on information acquired from another machine and generate a label, information acquired from a higher-level computer such as the fog computer 6, the cloud server 7, or the like, information about an environment (an environmental temperature or humidity, a visual information or voice information acquired from an external sensor, or the like). The label generation unit 140 provides the generated label to the anomaly data and stores the anomaly data with the label in the anomaly data storage unit 220.

Note that the learning unit 106 may perform relearning process in response to the label generation unit 140 storing anomaly data newly provided with a label related to an anomaly cause in the anomaly data storage unit 220. For example, after the previous learning process is performed to create a model, the learning unit 106 may perform a relearning process when a predefined predetermined number of anomaly data provided with the label related to the anomaly cause are added to the anomaly data storage unit 220. Further, the learning unit 106 may perform a relearning process when a predefined predetermined number of anomaly data provided with a label related to the same anomaly cause are added to the anomaly data storage unit 220. With such a configuration, also for anomaly data that occurs based on an anomaly cause which was unknown initially at installation, the anomaly classification device 1 can classify the anomaly cause later. Thus, continued use of the anomaly classification device 1 makes it possible to more suitably support the user in dealing with a failure.

The classification result output unit 150 is implemented when the CPU 11 of the anomaly classification device 1 illustrated in FIG. 1 executes the system program read from the ROM 12 to cause a calculation process using the RAM 13 or the nonvolatile memory 14 mainly performed by the CPU 11 and an output process using the interface 17, 20, or the like to take place. The classification result output unit 150 outputs a classification result of anomaly data provided by the anomaly data classification unit 108 to the display device 70 or a machine or a device connected to the network 5. Further, the classification result output unit 150 outputs information about anomaly data determined as an unknown anomaly by the known anomaly determination unit 107 to the display device 70 or a machine or a device connected to the network 5.

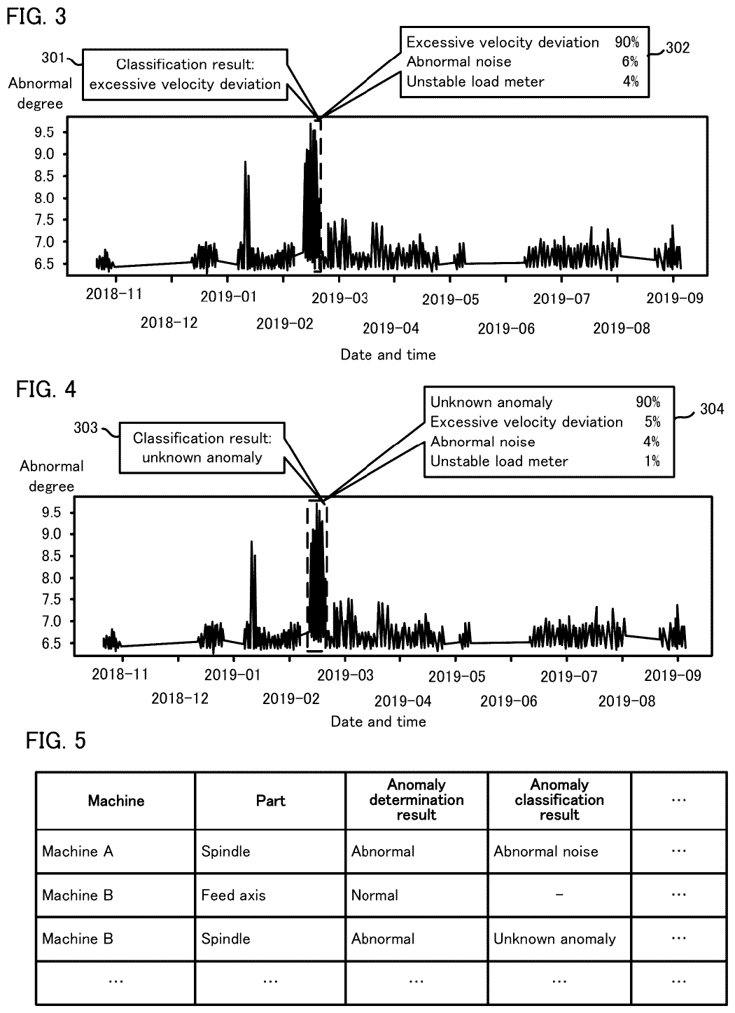

FIG. 3 is a display example of a classification result of anomaly data provided by the classification result output unit 150. In the example of FIG. 3, the abnormal degree indicated by anomaly data detected during an operation of an industrial machine is displayed in a graph in which the horizontal axis represents date and time. In this example, when particular anomaly data is selected, a classification result for the selected data is displayed. Conceivable display of a classification result may be display of only a single class with the highest certainty factor (301 in FIG. 3), list display of certainty factors for respective classes (302 in FIG. 3), graph display of certainty factors (a bar graph, a pie graph, a radar chart), or the like.

FIG. 4 is a display example when anomaly data determined by the known anomaly determination unit 107 to be not based on a known anomaly cause is selected. Also in this case, only an unknown anomaly with the highest certainty factor (303 in FIG. 4) may be displayed, and in addition, list display of certainty factors for respective classes (304 in FIG. 3) may be provided.

FIG. 5 is another display example of a classification result of anomaly data provided by the classification result output unit 150. As illustrated in FIG. 5 as an example, the classification result output unit 150 may list and display a history of anomaly causes related to anomalies that have occurred in a plurality of industrial machines 3.

The anomaly classification device 1 including the above configuration can classify anomaly patterns based on data obtained when an anomaly occurred even without requiring prior knowledge for classification of an anomaly cause based on a pattern obtained when the anomaly occurred and, further, can accurately determine an unknown anomaly by performing determination as to whether or not an anomaly that occurred in the industrial machine 3 is based on a known anomaly cause (known anomaly determination) separately from classification of an anomaly pattern.

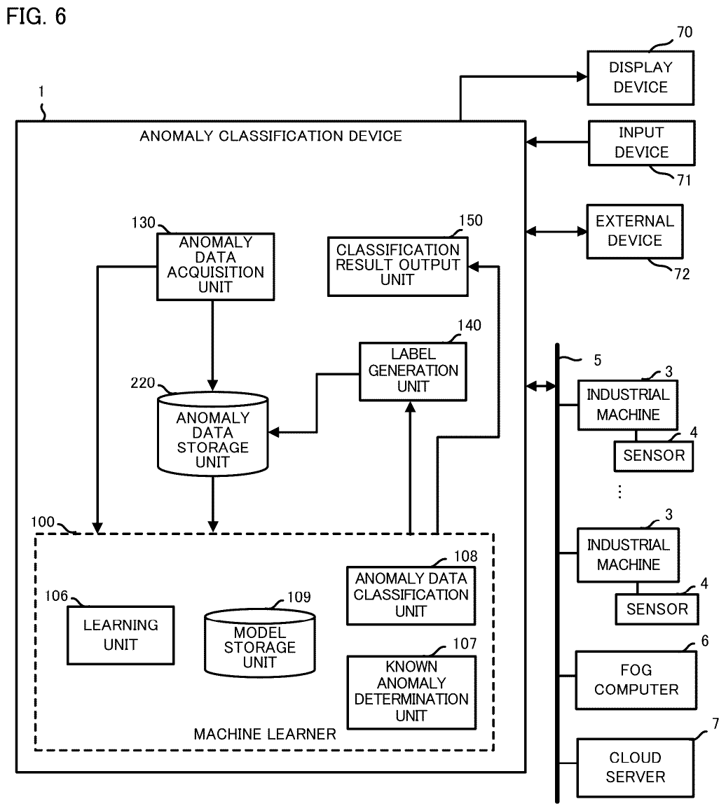

FIG. 6 illustrates functions of the anomaly classification device 1 according to a second embodiment of the present invention as a schematic block diagram.

Each function of the anomaly classification device 1 according to the present embodiment is implemented when the CPU 11 of the anomaly classification device 1 and the processor 101 of the machine learner 100 illustrated in FIG. 1 execute the system program and control the operation of each unit of the anomaly classification device 1 and the machine learner 100.

The anomaly classification device 1 according to the present embodiment has the same functions as respective functions of the anomaly classification device 1 according to the first embodiment except that the anomaly data acquisition unit 130 acquires anomaly data acquired in response to detecting occurrence of an anomaly in the industrial machine 3. In such a way, the anomaly classification device 1 can be utilized in order to externally determine that an anomaly occurred and classify anomaly data detected when the anomaly occurred. The anomaly classification device 1 has a function of classifying the cause of an anomaly for a known anomaly and, when an anomaly is determined as an unknown anomaly, creating a label and performing learning and thereby can sufficiently provide the advantageous effects of the invention of the present application.

As set forth, although one embodiment of the present invention has been described, the present invention is not limited to only the examples of the embodiments described above and can be implemented in various forms with addition of a suitable change.

1. An anomaly classification device that classifies an anomaly occurring in an industrial machine, the anomaly classification device comprising:
an anomaly data acquisition unit configured to acquire, as anomaly data, data related to a physical quantity detected when an anomaly occurred in an industrial machine;
an anomaly data storage unit configured to store the anomaly data;
a learning unit configured to use anomaly data stored in the anomaly data storage unit to create a model used for determining whether or not the anomaly data is anomaly data that is based on a known anomaly cause and a model used for classifying which anomaly cause the anomaly data belongs to;
a known anomaly determination unit configured to use the model created by the learning unit to determine whether or not the anomaly data is based on a known anomaly cause; and
an anomaly data classification unit configured to use the model created by the learning unit to classify which anomaly cause the anomaly data is based on.

2. The anomaly classification device according to claim 1 further comprising:
a data acquisition unit configured to acquire data related to a physical quantity detected in the industrial machine; and
an anomaly determination unit configured to determine whether an operation of the industrial machine is normal or abnormal based on the data acquired by the data acquisition unit,
wherein the anomaly data acquisition unit acquires, as anomaly data, data determined as abnormal by the anomaly determination unit.

3. The anomaly classification device according to claim 1,
wherein the learning unit creates the model, which is used for determining whether or not the anomaly data is anomaly data that is based on a known anomaly cause, and the model, which is used for classifying which anomaly cause the anomaly data belongs to, as a single common model,
wherein, for predetermined anomaly data, the known anomaly determination unit determines that the anomaly data is based on an unknown anomaly cause when a certainty factor output by the common model is below a predefined predetermined threshold for all classes, and
wherein the anomaly data classification unit outputs a classification result with determination that a class for which the certainty factor output by the common model is above a predefined predetermined threshold represents an anomaly cause of the anomaly data.

4. The anomaly classification device according to claim 1 further comprising a label generation unit configured to provide a label related to an anomaly cause to anomaly data determined by the known anomaly determination unit to be not based on a known anomaly cause.

5. The anomaly classification device according to claim 4 further comprising a classification result output unit configured to output a combination of the classification result provided by the anomaly data classification unit and the label provided by the label generation unit.

6. The anomaly classification device according to claim 4, wherein the label generation unit acquires a label to be provided to anomaly data via a user interface.

7. The anomaly classification device according to claim 4, wherein the label generation unit generates a label to be provided to anomaly data based on any of information about a machine to be diagnosed, information about another machine, and information about an environmental condition.

8. The anomaly classification device according to claim 4, wherein the learning unit relearns the model by using anomaly data provided with a label related to an anomaly cause by the label generation unit.
